(19) United States
(12) Patent Application Publication
(10) Pub. No.: US 2012/0110788 A1
(43) Pub. Date: May 10, 2012

(54) FRONT-LOADABLE TRACK MOUNTING SYSTEMS

(75) Inventor: Su-Wen Chen, Portland, OR (US)

(73) Assignee: 3FORM, INC., Salt Lake City, UT (US)

(21) Appl. No.: 13/381,624

(22) PCT Filed: Jul. 6, 2010
(86) PCT No.: PCT/US10/41028

§ 371 Date: Dec. 29, 2011

Related U.S. Application Data
(60) Provisional application No. 61/223,626, filed on Jul. 7, 2009.

(51) Int. Cl. E05D 15/00; B23P 11/00

(52) U.S. Cl. 16/94 R; 29/428

(57) ABSTRACT

A front-loadable track mounting system can include a track and mounting nut. The mounting nut and track can include corresponding features that allow a user to insert the mounting nut into a front opening in the track, and selectively lock the mounting nut in a desired position along the track. For example, the track can include opposing rails extending into the front opening of the track. The mounting nut can include that one or more ribs configured to rotate against the opposing rails of the track, and thereby, rotatably lock the mounting nut relative to the track.

### CROSS-REFERENCE TO RELATED APPLICATIONS

The present invention is a US National Stage Application corresponding to PCT application No. PCT/US10/41028, filed on Jul. 6, 2010, which claims the benefit of priority to U.S. Provisional Application No. 61/223,626, filed Jul. 7, 2009, entitled “Front Loadable Track System and Mounting Nut.” The entire content of each of the foregoing applications is incorporated by reference herein.

### BACKGROUND OF THE INVENTION

1. The Field of the Invention

This invention relates to apparatus, systems, and methods for suspending or mounting panels from a support structure as partitions, displays, barriers, treatments, or other structures.

2. Background And Relevant Art

Some recent architectural designs are now implementing synthetic, polymeric resins, which are used as partitions, walls, decor, etc., in offices and homes. In general, resin materials such as these are now popular compared with decorative cast or laminated glass materials, since resin materials can be manufactured to be more resilient and to have a similar transparent, translucent, or colored appearance as cast or laminated glass, but with less cost. Decorative resins can also provide more flexibility compared with glass at least in terms of color, degree of texture, gauge, weight, and impact resistance. Furthermore, decorative resins have a fairly wide utility since they can include a large variety of artistic colors, images, and shapes.

As mentioned above, one particular use of decorative resins may be in the panel form, where the panel might be used in conjunction with a panel mounting system as part of a partition, display, barrier, treatment, or other structure. One conventional type of panel mounting system includes mounting panels to cables suspended between support surfaces or from a ceiling. For example, a user (manufacturer, architect, assembler, installer, etc.) may use brackets to secure each panel to a suspended cable. Another conventional mounting system includes mounting panels to a structure using a plurality of standoffs. A conventional standoff typically includes a standoff barrel that attaches to the given support structure on one end, and a capped screw configured to twist inside the standoff barrel on an opposing end. The standoff screw is typically threaded through one side of a given perforation in a panel, and screwed into the standoff barrel on an opposing side of the panel perforation.

Unfortunately, conventional panel mounting systems, such as these, tend to suffer from a number of drawbacks. For instance, to secure cables or standoffs to a support surfaces, a user may drill anchor holes within which the user can secure opposing ends of the cable or the standoff barrels. Aligning the anchor holes, however, can be difficult in many design environments. Compounding this problem is the fact that once drilled, making adjustments to the anchor holes can be difficult, time consuming, or even impossible. Misalignment of cables or standoffs may cause unwanted stress on panels mounted thereto. Stress caused by mounting panels to misaligned cables or standoffs can cause panels to crack or otherwise damage the panels.

Some conventional mounting systems use track systems in an attempt to help avoid misaligning anchor holes. Typically, track systems include a track which a user mounts to a support surface. The user may then insert mounting hardware into one end of the track, and slide the mounting hardware within the track to the desired location. The user can then suspend a cable from the mounting hardware.

While conventional track systems can help reduce or minimize the misalignment of cables, conventional track systems may present other drawbacks. For example, some conventional track systems require the user to insert mounting hardware into an end of the track. This, in turn, may require that the user know the proper number and type of mounting hardware, and require the user to insert the mounting hardware in the proper order. Inserting the wrong number of mounting hardware components, or inserting the mounting hardware components in the wrong order, can require the user to remove the mounting hardware, and then reinsert the mounting hardware properly. Furthermore, in some design environments, the ends of the track may not be accessible after the installation of the track. In such cases it may be difficult, time consuming, or impossible to change the mounting hardware, or reconfigure any mounted panels.

Additionally, conventional mounting hardware is often free to move within a mounted track. The ability to freely move along the track can be convenient when installing the mounting hardware. This same ability to freely move within a track, however, can lead to movement cables or panels mounted to the track via the mounting hardware. As mentioned previously, movement in the mounting hardware can cause undesirable stresses in any panels mounted to the track.

### BRIEF SUMMARY OF THE INVENTION

One or more implementations of the present invention solve one or more of the forgoing, or other, problems in the art with systems, methods, and apparatus for mounting or suspending panels that a user can easily adjust and configure for a wide variety of design environments. For example, one or more implementations of the present invention include a front-loadable track mounting system having mounting hardware that a user can insert anywhere along a front opening of the track. Thus, a user need not have to insert the mounting hardware into the ends of the track. In particular, the user can selectively insert, position, and lock a mounting nut within the track, and secure a wide variety of mounting components to the mounting nut. Accordingly, implementations of the present invention can allow a user to easily adapt the front-loadable track mounting system to the environment of use and provide a number of secure mounting options.

For instance, one implementation of a mounting system can include a track having a generally U-shaped cross-section. The track can also include a pair of opposing rails extending into an opening defined by the U-shaped cross-section. The mounting system can further include a mounting nut having a body and at least one rib extending generally perpendicularly from a surface of the body. The mounting nut can be configured to be locked within the track when the body is inserted into the opening and rotated, such that the at least one rib abuts against the pair of opposing rails.

Additionally, one implementation of a decorative panel system can include a first track comprising a pair of opposing rails extending into opposing sides of an opening of the first track. The panel system can also include a mounting nut having a body and a pair of ribs extending from a surface of the body. The mounting nut can be positioned within the first track. In particular, the pair of ribs can extend between and against the opposing rails. The panel system can further include at least one decorative architectural panel secured to the mounting nut via one or more mounting brackets.

In addition to the foregoing, a method of mounting a decorative architectural panel can involve securing a track having opposing rails to a support structure. The method can also involve inserting the mounting nut into an opening in the track between the opposing rails. The method can then involve rotating the mounting nut into a locked position. In the particular, the method can involve rotating the mounting nut so the surface of the mounting nut rests upon the rails of the track, and the first and second ribs are positioned against the opposing rails of the track so further rotation of the mounting nut relative to the track is prevented. Additionally, the method can involve securing a decorative architectural panel to the mounting nut via a mounting bracket.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of a panel system including a plurality of panels suspended between support surfaces by a front-loadable track mounting system in accordance with an implementation of the present invention;

FIG. 2A illustrates a perspective view of a track of the front-loadable track mounting system of FIG. 1;

FIG. 2B illustrates an end view of the track of FIG. 2A;

FIG. 3A illustrates a perspective view of a mounting nut of the front-loadable track mounting system of FIG. 1;

FIG. 3B illustrates a top view of the mounting nut of FIG. 3A;

FIG. 4A illustrates an end view of an unassembled front-loadable track mounting system, including a track, mounting nut, and threaded rod, in accordance with an implementation of the present invention;

FIG. 4B illustrates an end view of the mounting nut and the threaded rod of FIG. 4A in a release position within the track of FIG. 4A;

FIG. 4C illustrates an end view of the mounting nut and the threaded rod of FIG. 4A fully inserted, and twisted into a locked position, within the track of FIG. 4A;

FIG. 5 illustrates a perspective view of an implementation of a mounting component with features configured to mate with a mounting nut in accordance with an implementation of the present invention; and

FIG. 6 illustrates a top view of another panel system including a panel secured to a support structure via the mounting component of FIG. 5 and a front-loadable track mounting system in accordance with an implementation of the present invention.

### DETAILED DESCRIPTION OF THE PREFERRED EMBODIMENTS

Implementations of the present invention provide systems, methods, and apparatus for mounting or suspending panels that a user can easily adjust and configure for a wide variety of design environments. For example, one or more implementations of the present invention include a front-loadable track mounting system having mounting hardware that a user can insert anywhere along a front opening of the track. Thus, a user need not have to insert the mounting hardware into the ends of the track. In particular, the user can selectively insert, position, and lock a mounting nut within the track, and secure a wide variety of mounting components to the mounting nut. Accordingly, implementations of the present invention can allow a user to easily adapt the front-loadable track mounting system to the environment of use and provide a number of secure mounting options.

In particular, one or more implementations include a track and a mounting nut that a user can selectively load into a front opening of the track. More specifically, a user can mount the track in a design environment. Then at a later time, for example, after the construction of a partition, ceiling, or wall renders the ends of the track inaccessible, the user can mount a panel to the previously mounted track. In one or more implementations, for instance, a user can insert a desired number mounting nuts into the front opening of the track and secure corresponding mounting hardware to the mounting nuts. Further, a user can insert additional mounting hardware between previously installed mounting hardware without the need to remove any of the previously installed mounting hardware. One will appreciate that such systems can provide a user with great versatility.

In addition to the foregoing, various components, systems, and methods described herein can allow a user to quickly and efficiently align or reposition mounting hardware with respect to a support surface. For instance, one or implementations can allow a user to selectively position a mounting nut along a track. The user can then selectively lock the mounting nut in a desired position along the track. If desired, the user can then unlock the mounting nut, and move the mounting nut to another position along the track. Along similar lines, the user can easily add or remove mounting nuts and associated mounting hardware as desired. Thus, one or more implementations of the present invention provide a secure and reliable mount which a user can easily move or otherwise reconfigure.

Furthermore, at least one implementation of the present invention includes a mounting nut that is configured to connect to a wide variety of different mounting hardware to provide a user with versatility. For example, in one or more implementations, the mounting nuts are configured to support a cable, a standoff, a 3-D spider bracket, or other mounting component. One will thus appreciate that a user can employ a front-mountable track system of the present invention to suspend one or more panels from a support structure using one or more cables secured to a track. Alternatively, a user can mount a panel to a support structure using one or more standoffs or other mounting components secured within a track. Thus, one or more implementations of the present invention can provide a user with a great deal of versatility.

As mentioned above, users may choose to use components of the present invention to suspend or mount panels, such as resin-based panels, because they can allow the panels to be quickly and easily mounted and adjusted. As used herein, the terms “resin panel” and “resin-based panel” refer to panels comprising a substrate of one or more layers or sheets formed from any one of the following thermoplastic polymers (or alloys thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like.

As a preliminary matter, implementations of the present invention are described herein primarily with reference to mounting panels, and particularly resin-based panels. One will appreciate, however, that a panel, particularly a resin-based panel, is only one type of “structure” which a user may using the components, systems, and methods described herein. For example, a user can use implementations of the present invention to mount not only resin panels, as such, but also glass panels, to a given support structure. Furthermore, one will appreciate that a user can use various components and mounting assemblies described herein to mount other types of structures having different material compositions, such as objects comprising wood, stone, fiberglass, or the like, which may or may not exhibit primarily panel-like dimensions as described herein. Reference herein, therefore, to panels, or even resin panels, as such, is primarily for convenience in description.

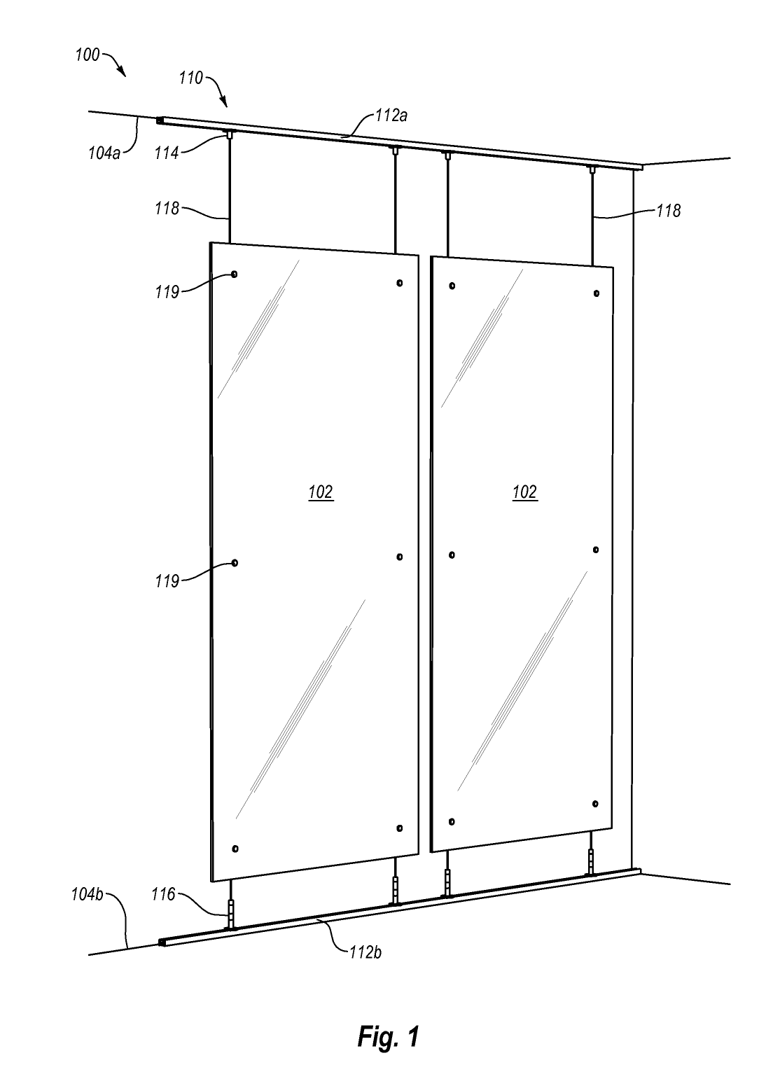

As mentioned previously, one or more implementations of the present invention include front-loadable track mounting systems configured to mount or suspend one or more panels to a support structure. For example, FIG. 1 illustrates a panel system 100, including a plurality of panels 102 suspended between opposing support structures 104a, 104b via a front-loadable track mounting system 110. In particular, the front-loadable track mounting system 110 includes an upper track 112a secured to a ceiling structure 104a, and a lower track 112b secured to a floor structure. 104b. In alternative implementations, the front-loadable track mounting system 110 can include a single track suspending one or more panels from a single support surface. In yet additional implementations, the front-loadable track mounting system 110 can include more than two tracks either. Still further the front-loadable track mounting system 110 can suspend a panel from, or mount a panel between, any number of support structures.

FIG. 1 also shows that the upper track 112a and the lower track 112b are aligned opposite one another in an approximately parallel orientation. One will appreciate that this can allow the user to mount panels in a substantially vertical orientation as partitions or room dividers. In alternative implementations, the user can mount the tracks 112a, 112b in alternative arrangements to orient the cables, and panels secured thereto, in a wide variety of different configurations. For example, the user can mount the tracks 112a, 112b between opposing walls and use the panels as shelves. One will thus appreciate in light of the disclosure herein that a user can install the components of the present invention in a wide variety of configurations.

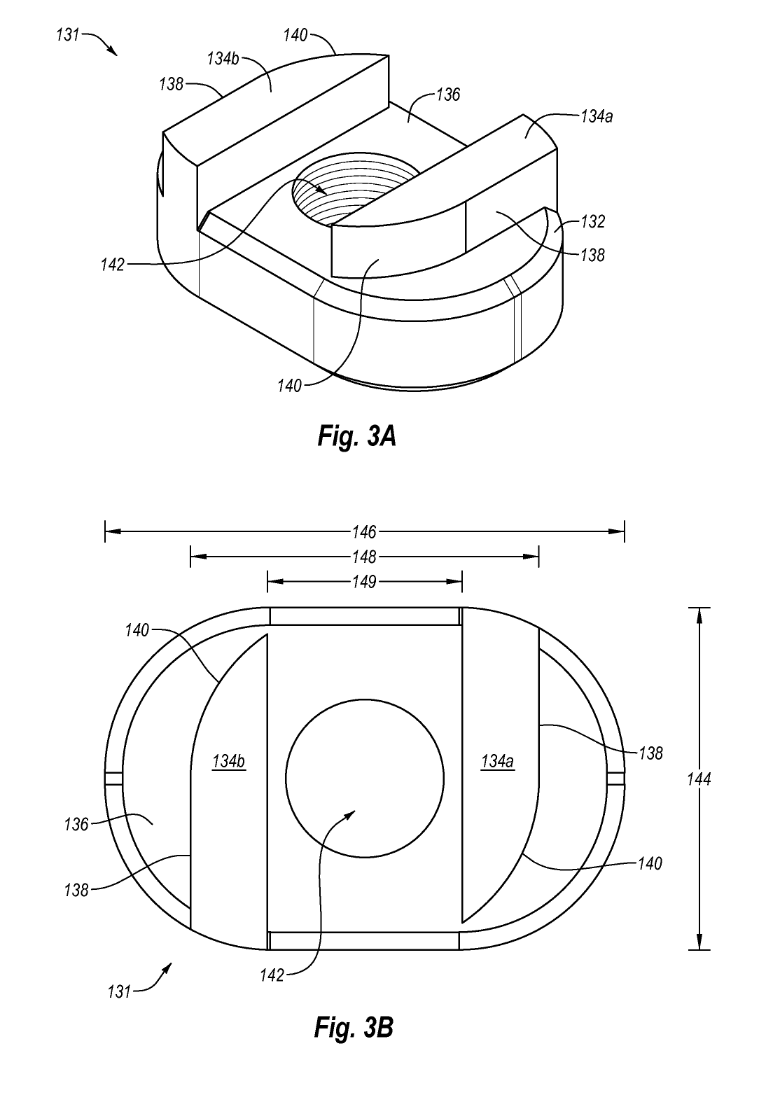

In any event, each track 112a, 112b can include one or more mounting nuts (FIGS. 3A and 3B) secured therein. Each mounting nut, in turn, can receive or secure a mounting component either directly or indirectly thereto. For example, FIG. 1 illustrates a front-loadable track mounting system 110 that includes mounting nuts indirectly secured to mounting components. In particular, FIG. 1 illustrates that each mounting nut within the upper track 112a can include a cable coupler 114 secured thereto. Each cable coupler can in turn hold an upper end of a cable 118. A cable tensioner 116 can similarly secure the lower end of each cable 118 to a mounting nut within the lower track 112b. The cable tensioners 116 can allow a user to increase or decrease the tension on a cable 118 without rotating or otherwise moving the cable 118.

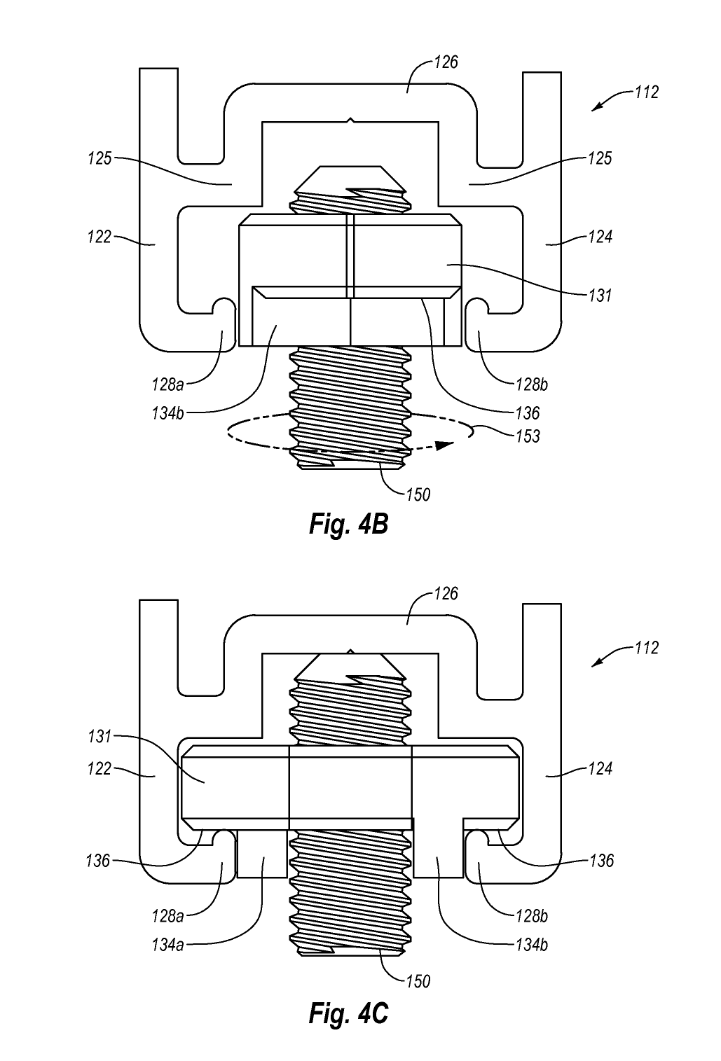

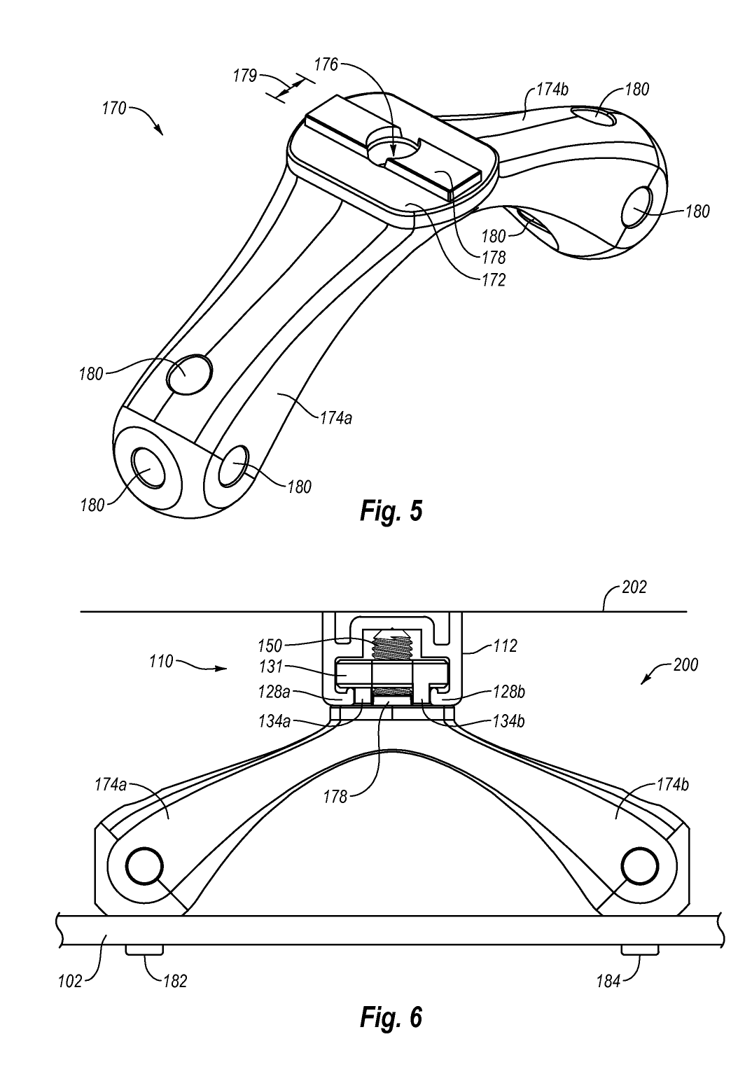

In any event, each cable 118 can include one or more mounting components securing a panel 102 thereto. In alternative implementations, such as that shown and described in reference to FIG. 6, each mounting nut can include a mounting component secured directly thereto. As used herein the term “mounting component” refers to a component configured to directly hold a portion of a panel 102 and secure the panel to another structure. Thus, mounting components include standoffs, panel connectors, 3-D spider connectors (FIG. 5), brackets, and other components.

For instance, FIG. 1 illustrates that each panel 102 is connected to a cable 118 via a capped screw 119 extending through the panel 102 and into a barrel (not shown) secured to the cable 118. In alternative implementations, a panel connector can secure an edge of the panels 102 to a cable 118.

Additionally, as shown in FIG. 1, one or more implementations of a panel system 100 can securely suspend or hang panels, such as resin-based panels 102, from a ceiling 104a or other support structure, while also preserving an intended aesthetic for the partitions. For example, one or more the panel systems of the present invention do not require frames or other hardware that can cover significant portions of the mounted partitions, or otherwise detract from the aesthetic features of the panels 102. In particular, FIG. 1 illustrates that the panels 102 do not include a frame or other hardware covering or otherwise obscuring significant portions of the sides or viewable surfaces of the resin-based panels 102. Specifically, FIG. 1 illustrates that the only hardware that may be visible is one or more tracks (i.e., track 112a, 112b), one or more cables 118, and one or more mounting components (i.e., capped screws 119).

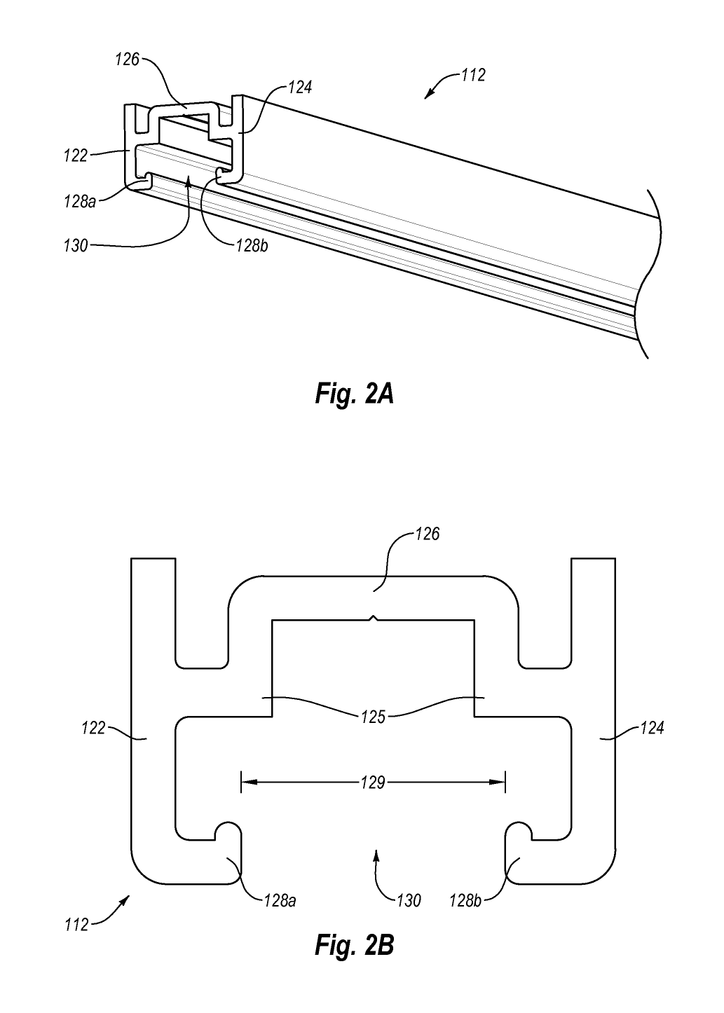

FIGS. 2A and 2B and the corresponding text, describe a number of the details and features of a track 112 of a front-loadable track mounting system 110 in accordance with one or more implementations of the present invention. Specifically, FIGS. 2A and 2B illustrate that the track 112 can include a generally U-shaped cross-section. In particular, the track 112 can include opposing side walls 122, 124, and a back wall 126 extending there between.

In one or more implementations, the back wall 126 can include a generally planar portion, as illustrated by FIGS. 2A and 2B. The generally planar portion of the back wall 126 can allow a user to mount the track 112 to a support surface, such as a ceiling 104a, or floor 104b (FIG. 1). Opposite the back wall 126, the track 112 can include opposing rails 128a, 128b extending from the side walls 122, 124 into a front opening 130 defined by the U-shaped cross-section.

The front opening 130 of the track 112 can extend along the length of the track 112. Thus, as explained in greater detail below, a user can load a mounting nut 131 (FIGS. 3A and 3B) into the front of the track 112 anywhere along the length of the track 112. In alternative implementations, a user can insert a mounting nut into either end of the track 112.

As shown by FIG. 2B, the opposing rails 128a, 128b can define an opening distance or size 129 of the opening 130. The opening distance 129 can have a size to allow the track 112 to receive a mounting nut 131. Similarly, the cavity within the track 112 can have a size and shape corresponding to the size and shape of a mounting nut 131, and thus, the track 112 can receive and hold a mounting nut 131 therein.

In some implementations of the present invention, the track 112 can include stop features that can control the position of a mounting nut 131 within the track 112. For example, FIG. 2A illustrates that the track 112 can include protrusions 125 that extend into the cavity of the track 112. The protrusions 125 can act as a stop and control how far a user can insert a mounting nut 131 into the track 112.

FIGS. 3A and 3B illustrate perspective and top views, respectively, of one implementation of a mounting nut 131. The mounting nut 131 can include a body 132 having a surface 136. Additionally, the mounting nut 131 can include one or more ribs 134a, 134b, extending from the surface 136 of the body. As explained in greater detail below, the features of the mounting nut 131 can allow a user to selectively insert within, position along, and lock the mounting nut 131 to a track 112.

For instance, the body 132 of the mounting nut 131 can have a size and shape that allow a user to insert the mounting nut 131 into the opening 130 of the track 112 when positioned in a first or release position. Furthermore, the body 132 can also have a size and shape that allow a user to manipulate the mounting nut 131 while in the track 112 from the release position to a locked position. When in the locked position, the features of the mounting nut 131 can prevent the mounting nut 131 from exiting the track 112 through the opening 130.

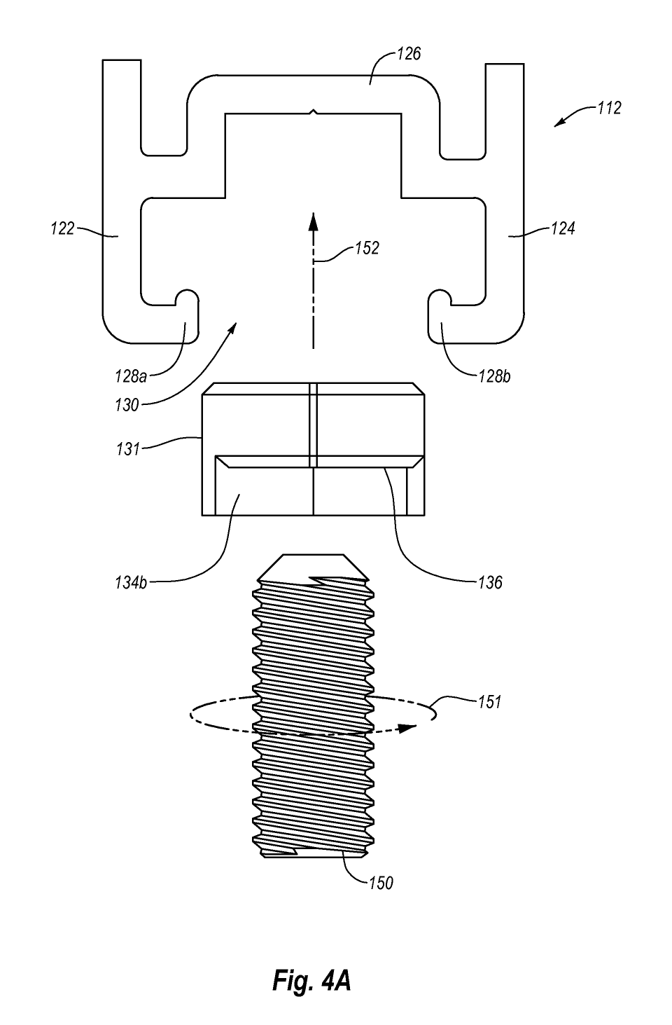

For example, FIG. 3B illustrates that the body 132 can have a width 144 and a length 146. The width 144 of the body 132 can be smaller than the opening distance 129 of the opening 130 of the track 112 (FIG. 2B). Thus, as explained in greater detail below, when aligned lengthwise with respect to the track 112 (a release position shown in FIG. 4A), a user can insert the mounting nut 131 into the track 112 through the opening 130.

Additionally, the length 146 of the body 132 can be larger than the opening distance 129 of the opening 130 of the track 112. Thus, when positioned widthwise within the track 112 (a locked position shown in FIG. 4C), the length 146 of the body 132 can prevent the mounting nut 131 from passing back through the opening 130 of the track 112. Accordingly, a user can selectively load the mounting nut 131 into the front opening 130 of the track 112, and selectively lock the mounting nut 131 within the track 112.

As mentioned previously, the mounting nut 131 can include one or more ribs 134a, 134b. For example, FIGS. 3A and 3B illustrate that the mounting nut 131 can include a first rib 134a and a second rib 134b. In alternative implementations, the mounting nut 131 can include a single rib, or more than two ribs.

As explained in greater detail below, the ribs can prevent the mounting nut 131 from rotating out of the locked position (FIG. 4C) and into the release position (FIG. 4A). For instance, when the mounting nut 131 is positioned in the locked position (FIG. 4A), the first rib 134a and the second rib 134b can extend between and against the opposing rails 128a, 128b of the track 112. Thus, when in the locked position, the first and second ribs 134a, 134b can prevent further rotation of the mounting nut 131 relative to the track 112.

In particular, the first rib 134a and the second rib 134b can each include a flat edge 138 and a rounded edge 140. As shown in FIG. 3A, in one or more implementations, the flat edges 138 and the rounded edges 140 can extend generally perpendicularly from the surface 136 of the mounting nut 131. The distance 148 between the flat edges 138 of the first and second ribs 134a, 134b can be approximately equal to the opening distance 129 between the opposing rails 124a, 124b of the track 112 (FIG. 2A). Thus, when rotated into the locked position, the flat edges 138 of the first and second ribs 134a, 134b can rest against the opposing rails 124a, 124b. This contact between the flat or outside edges 138 of the first and second ribs 134a, 134b against the opposing rails 124a, 124b of the track 112 can stop the mounting nut 131 from turning when positioned in the locked position (FIG. 4C), as explained in greater detail below.

One will appreciate in light of the disclosure herein that the rounded edges 140 of the first and second ribs 134a, 134b can allow the mounting nut 131 to rotate with respect to the track 112. In particular, the rounded edges 140 can allow the mounting nut 131 to rotate clockwise while first and second ribs 134a, 134b are positioned between the opposing rails 128a, 128b. Thus, the rounded edges 140 can allow a user to rotate the mounting nut 131 within the track 112, until the outside or flat edges 138 come in contact with opposing rails 128a, 128b and prevent further clockwise rotation of the mounting nut 131.

As previously mentioned, the mounting nut 131 can include a connection member 142 to which a user can secure additional mounting hardware, as explained in greater detail below. For example, FIGS. 3A and 3B illustrates that the mounting nut 131 can include a threaded female receptacle 142. The threaded female receptacle 142 can receive a screw or bolt with complementary threading, as described below. In alternative implementations, the connection member 142 can comprise a male rod to which a user can secure additional hardware.

In addition to acting as a rotation stop, the first and second ribs 134a, 134b can allow a user to connect additional mounting hardware to the track 112. For example, as illustrated by FIG. 3B, a separation distance 149 can separate the first rib 134a from the second rib 134b. As explained in greater detail below, the separation distance 149 can correspond to mounting features of various mounting components. In particular, a user can insert a mounting ridge of a mounting component between the first and second ribs 134a, 134b to provide a secure mount to the mounting nut 131 and track 112.

FIGS. 4A-4C, and the corresponding text, show or describe in further detail a process of securing a mounting nut 131 to track 112 in accordance with one or more implementations. Referring now to FIG. 4A, an exploded view of the components of a front-mountable track mounting system in accordance with one or more implementations are shown. In particular, FIG. 4A illustrates an end view of a track 112, a mounting nut 131, and a threaded rod 150.

To mount the mounting nut 131 to the track 112, a user can thread the threaded rod 150 a few rotations into the mounting nut 131, as shown by the arrow 151 of FIG. 4A. Thereafter, or even before if desired, the user can align the mounting nut 131 into the release position. In other words, the user can align the mounting nut 131 lengthwise with the opening 130 of the track 112. When in the release position, as shown by FIG. 4A, the user can insert the mounting nut 131 into the front of the track 112 through the opening 130, as indicated by arrow 152 of FIG. 4A.

One will appreciate in light of the disclosure herein that the ability to mount the mounting nut 131 into the front of the track 112 can provide many benefits. For example, in some design environments there may not be sufficient space to insert a mounting nut 131 into the end of the track 112. In other design environments, a user may need to mount the track 112 before the rest of the design space is completed. In such cases, the ability to later add the mounting nut 131, mounting components, and panels 102 to the track 112 can prevent damage to the panels 112 during the finishing of the design space.

Referring again to the Figures, the user can insert the mounting nut 131 into the track 112 until the surface 136 of the mounting nut 131 passes the opposing rails 128a, 128b, as shown in FIG. 4B. The protrusions 125 of the track 112 can control how far a user can insert the mounting nut 131 into the track 112. In particular, the protrusions 125 can prevent the first and second ribs 134a, 134b from passing beyond the opposing rails 128a, 128b.

Once fully inserted into the track 112, or even before if desired, the user selectively slide the mounting nut 131 along the length of the track 112 to a desired position. This can allow the user to align the mounting nut 131 with a corresponding mounting nut or anchor point. Thereafter, the user can rotate the threaded rod 150 as indicated by arrow 153.

The rotation of the threaded rod 150 can cause the mounting nut 131 to rotate within the track 112. In particular, the mounting nut 131 can rotate from the release position (FIG. 4B) to the locked position (FIG. 4C). As shown by FIG. 4C, when in the locked position, the mounting nut 131 is at least partially aligned widthwise with the track 112. When in the locked position, the surface 136 of the mounting nut 131 can rest against (i.e., upon) the opposing rails 128a, 128b, and thus prevent the mounting nut 131 from passing back through the opening 130 of the track 112.

Additionally, FIG. 4C illustrates that when in the locked position, the first and second ribs 134a, 134b can reside between and abut against the opposing rails 128a, 128b of the track 112. In particular, the flat edges 138 of the first and second ribs 134a, 134b can rest against the inner edges of the opposing rails 128a, 128b. In at least one implementation, the contact between the flat edges 138 of first and second ribs 134a, 134b and the opposing rails 128a, 128b can prevent further rotation of the mounting nut 131. The prevention of further rotation can prevent the mounting nut 131 from rotating back into the release position.

In addition to locking the rotation of the mounting nut 131 relative to the track 112, the user can also lock the translation of the mounting nut 131 relative to the track 112. For example, the user can continue to thread the threaded rod 150 until the threaded rod 150 abuts against the back wall 126. The thread rod 150 can thus lock the mounting nut 131 in a desired position along the track 112.

In addition to locking the mounting nut 131 in a desired position along the track 112, the threaded rod 150 can function as an attachment point to which a user can indirectly or directly secure mounting components. For example, the user can secure a cable 118 (FIG. 1) to the threaded rod 150 via a cable coupler 114 or tensioner 116. The user can then secure one or more panels 102 to the cable 118 using one or more mounting components, such as capped screws 119 (FIG. 1),

Alternatively, the user can secure a mounting component directly to the threaded rod 150 and mounting nut 131. In particular, as noted previously, the first and second ribs 134a, 134b of the mounting nut 131 can mate with corresponding features of a mounting component. For example, the first and second ribs 134a, 134b can include a separation distance 149 (FIG. 3B). In one or more implementations, the separation distance 149 can have a size, and the inner edges of the first and second ribs 134a, 134b, can have a shape, configured to receive and mate with a mounting ridge of mounting component, such as a VERSA Spiders or VERSA Brackets sold by 3FORM, Inc. of Salt Lake City, Utah.

For example, FIG. 5 illustrates a perspective view of a 3D spider 170 which a user can mate with a mounting nut 131. As shown by FIG. 5, the 3D spider 170 can include a first leg 174a and a second leg 174b. Each leg 174a, 174b can include one or more mounting holes 180 to which a user can secure a panel 102 via a capped screw 119. Additionally, the 3D spider 170 can include a mounting surface 172 having a rib or mounting ridge 178 extending there from. The mounting ridge 178 can have a width 179 approximately equal to the separation distance 149 between the first and second ribs 134a, 134b of a mounting nut 131. The 3D spider 170 can also include a connector 176, such as a threaded female receptacle or hole, for mounting the 3D spider 170 to a component, such as a mounting nut 131.

Referring now to FIG. 6, a top view of a panel system 200 including a panel 102 mounted to a wall structure 202 is shown. In particular, the panel system 200 includes a front-loadable track mounting system 110 securing a panel 102 to the wall structure 202. The front-loadable track mounting system 110 can include a track 112 and a mounting nut 131 secured within the track 112. Additionally, the panel system 200 can include a mounting component (i.e., 3D spider 170) secured directly to the mounting nut 131. The 3D spider 170 in turn can secure the panel 102 to the mounting nut 131 via a plurality of capped screws 182.

To secure the 3D spider to the mounting nut, FIG. 6 further illustrates that a user can position the mounting ridge 178 of the 3D spider 170 between the first and second ribs 134a, 134b of the mounting nut 131. The user can then secure the 3D spider 170 to the mounting nut 131 using the threaded rod 150. One will appreciate in light of the disclosure herein, that the mating configuration of the mounting ridge 178 and the first and second ribs 134a, 134b can allow a user to install the 3D spider 170 in a flush configuration with the track 112. Furthermore, the mating configuration of the mounting ridge 178 and the first and second ribs 134a, 134b can prevent lateral movement of the 3D spider 170 relative to the track 112 after installation.

Implementations of the present invention can also include methods of assembling and mounting panels to a support structure. The following describes at least one implementation of a method of mounting a panel to a support structure using a front-loadable track mounting system with reference to the components and diagrams of FIGS. 1 through 6. Of course, as a preliminary matter, one of ordinary skill in the art will recognize that the methods explained in detail herein can be modified to install a wide variety of configurations using one or more components of the present invention. For example, various acts of the method described can be omitted or expanded, and the order of the various acts of the method described can be altered as desired.

Thus, according to one method of the present invention, a user can secure at least one track 112 having a pair of opposing rails 128a, 128b to a support structure 104a, 104b, 202. For example, the user can secure a back wall 126 of the track 112 to a support surface 104a, 104b, 202 using one or more fasteners. One will appreciate in light of the disclosure herein that the user can select an appropriate fastener based on the type of support structure (i.e., wood, concrete, drywall etc.).

Once the track 112 is secured to a support surface 104a, 104b, 202, or even before if desired, the user insert a mounting nut 131 into a front opening 130 in the track 112 between opposing rails 128a, 128b. For example, the user can position the mounting nut 131 into a release position by aligning the mounting nut 131 lengthwise with the track 112. The user can then insert the mounting nut 131 into the opening 130 of the track 112 until the surface 136 of the mounting nut 131 passes the opposing rails 128a, 128b.

The method can also include rotating the mounting nut 131 into a locked position. For example, the user can rotate the mounting nut 131 within the track 112 until the surface 136 of the mounting nut 131 rests upon the opposing rails 128a, 128b of the track 112. Furthermore, the user can rotate the mounting nut 131 within the track 112 until the first and second ribs 134a, 134b are positioned against the opposing rails 128a, 128b of the track 112, and thus, prevent further rotation of the mounting nut 131 relative to the track 112. In some implementations, the user can rotate a threaded rod 150 into the mounting nut 131, which thereby causes the mounting nut 131 to rotate.

Additionally, the method can include securing a decorative architectural panel 102 to the mounting nut 131 via a mounting bracket 119, 170. For example, the user can indirectly secure a bracket to the mounting nut 131 using a cable 118. The user can then secure the panel 102 to the cable 118 using a mounting component 119. Alternatively, the user can insert a mounting ridge 178 of a mounting component 170 between the first and second ribs 134a, 134b of the mounting nut 131. Then user can then secure the mounting component 170 to the mounting nut 131 using a threaded rod 150. The user can then secure a panel 102 to the mounting component 170.

Accordingly, FIGS. 1-6 and the corresponding text, therefore, specifically show, describe, or otherwise provide a number of systems, components, apparatus, and methods for efficiently mounting, moving, or repositioning mounting hardware and panels secured thereto. For instance, the various components, systems, and methods described herein can allow a user to quickly and efficiently align or reposition mounting hardware with respect to a support surface. Additionally, at least one implementation of the present invention includes systems, components, apparatus configured to connect to a wide variety of different mounting hardware to provide a user with versatility.

The present invention may be embodied in other specific forms without departing from its spirit or essential characteristics. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A front-loadable track and nut mounting system, comprising:
a track having a generally U-shaped cross-section and a pair of opposing rails extending into an opening defined by the U-shaped cross-section; and
a mounting nut having a body and at least one rib extending generally perpendicularly from a surface of the body;
wherein the mounting nut is configured to be locked within the track when the body is inserted into the opening and rotated, such that the at least one rib abuts against the pair of opposing rails.

2. The front-loadable track and nut mounting system as recited in claim 1, further comprising a connection member configured to connect a mounting component to the mounting nut.

3. The front-loadable track and nut mounting system as recited in claim 2, wherein the connection member comprises a female receptacle extending at least partially through the body.

4. The front-loadable track and nut mounting system as recited in claim 2, wherein the connection member comprises a threaded rod extending from the surface of the body.

5. The front-loadable track and nut mounting system as recited in claim 1, wherein the at least one rib comprises a rounded edge and a flat edge.

6. The front-loadable track and nut mounting system as recited in claim 5, further comprising:
a second rib having a second rounded edge and a second flat edge;
wherein a distance between the flat edges of the at least one rib and the second rib is approximately equal to an opening distance between the pair of opposing rails.

7. The front-loadable track and nut mounting system as recited in claim 2, further comprising a cable configured to be secured to the connection member.

8. The front-loadable track and nut mounting system as recited in claim 6, further comprising a mounting bracket configured to be secured to the connection member, the mounting bracket comprising a ridge configured to be inserted between the first rib and the at least a second rib of the mounting nut.

9. A decorative panel system, comprising:
a first track comprising a pair of opposing rails extending into opposing sides of an opening of the first track;
a mounting nut having a body, and a pair of ribs extending from a surface of the body, the mounting nut being positioned within the first track with the pair of ribs extending from the surface of the body between and against the opposing rails of the track; and
at least one decorative architectural panel secured to the mounting nut via one or more mounting brackets.

10. The decorative panel system as recited in claim 9, further comprising:
a second track positioned opposite the first track; and
a cable extending from the mounting nut to the second track.

11. The decorative panel system as recited in claim 10, further comprising a cable bracket securing the at least one decorative architectural panel to the cable.

12. The decorative panel system as recited in claim 10, further comprising a second mounting nut positioned within the second track, the second mounting nut having a surface positioned on a second pair of opposing rails, and a second pair of ribs extending between and against a second pair of opposing rails of the second track.

13. The decorative panel system as recited in claim 9, wherein each of the pair of ribs comprises a rounded edge and a flat edge.

14. The decorative panel system as recited in claim 13, wherein:
a distance between the flat edges of each rib of the pair of ribs is approximately equal to an opening distance between the opposing rails; and
the flat edges of each rib of the pair of ribs are configured to prevent rotation of the mounting nut relative to the track when rotated against the opposing rails.

15. The decorative panel system as recited in claim 9, further comprising a mounting bracket having a ridge matedly secured between the pair of ribs.

16. The decorative panel system as recited in claim 15, further comprising a rod threaded within the mounting bracket and the mounting nut.

17. A method of mounting a decorative architectural panel to one or more support structures using a mounting nut having a surface, and first and second ribs extending from the surface, comprising:
securing a track having opposing rails to a support structure;
inserting the mounting nut into a front opening in the track between the opposing rails;
rotating each rib of the pair of ribs wherein:
the surface of the mounting nut rests upon the opposing rails of the track, and
the first and second ribs are positioned against the opposing rails of the track and prevent further rotation of the mounting nut relative to the track; and
securing a decorative architectural panel to the mounting nut via a mounting bracket.

18. The method as recited in claim 17, further comprising:
securing a cable to the mounting nut; and
securing the mounting bracket to the cable.

19. The method as recited in claim 18, further comprising:
sliding the mounting nut along the track to a desired position; and
securing a threaded rod through the mounting nut and against the track, thereby locking the mounting nut in the desired position.

20. The method as recited in claim 18, further comprising:
inserting a ridge of the mounting bracket between the first and second ribs of the mounting nut; and
securing a threaded rod into the mounting bracket and the mounting nut.
